(19) United States
(12) Patent Application Publication
(10) Pub. No.: US 2023/0051149 A1
(43) Pub. Date: Feb. 16, 2023

(54) Sanborn Leveling Board

(71) Applicant: David Laurence Sanborn, Gainesville, GA (US)

(72) Inventor: David Laurence Sanborn, Gainesville, GA (US)

(21) Appl. No.: 17/445,087

(22) Filed: Aug. 14, 2021

(51) Int. Cl. G01C 9/28

(52) U.S. Cl. CPC G01C 9/28

(57) ABSTRACT

Since the invention of the leveling board tool, as shown in FIG. 1 and FIG. 3, users can easily obtain a level work surface easily by turning the thumb screws, as shown in FIGS. 2(5) and 3(5), attached to the flat board, as shown in FIG. 1(1) and FIG. 3(7), until the bubbles are centered within the attached bubble levels, as shown in FIG. 1(3) and FIG. 3(3). This has become a tool used by multiple users for leveling equipment, leveling chemical measurements, and leveling liquid media in art projects.

The Sanborn Leveling Board, also known as Leveling Board or Leveling Table, as shown in FIG. 1, was developed to provide a level work surface for the pouring of liquids. The leveling board can be made from wood or plastic, as shown in FIG. 1, or glass, as shown in FIG. 3.

The leveling board, as shown in FIG. 1, is built with a plastic or wood flat board, as shown in FIG. 1(1), four knurled thumb screws, as shown in FIG. 2(5), four threaded insert nuts, as shown in FIG. 2(6), two bubble level brackets, as shown in FIG. 1(2), four bubble level bracket screws, as shown in FIG. 1(4), and two bubble levels, as shown in FIG. 1(3).

Two additional bubble levels as shown in FIG. 1(3) and two additional bubble level brackets, as seen in FIG. 1(2), can be attached to the leveling board on the opposite sides, if desired, but are not needed to level the leveling board. Some customers insist on this option.

The glass version of the leveling board, as shown in FIG. 3, is built with a flat tempered glass board, as shown in FIG. 3(7), two plastic bubble level brackets, as shown in FIG. 3(8), two bubble levels, as shown in FIG. 3(3), four coupling nut brackets, as shown in FIG. 4(9), four coupling nuts, as shown in FIG. 4(10), and four knurled thumb screws, as shown in FIG. 3(5).

### BRIEF SUMMARY OF THE INVENTION

The Leveling Board, as shown in FIG. 1, eases the user's efforts in leveling their work surface. The user places the leveling board, as shown in FIG. 1, on their work surface, turns the attached thumb screws, as shown in FIG. 2(5), until the bubbles all move to the center of the attached levels, as shown in FIG. 1(3). This provides an easily acquired and more level work surface.

No surface is perfectly level; however, the leveling board, as shown in FIG. 1 and FIG. 3, allows the user to improve the levelness of their work surface. The glass leveling board, as shown in FIG. 3, is more uniformly flat than the plastic or wood leveling board, as shown in FIG. 1, but is typically more expensive to build.

The Leveling Board, as shown in FIG. 1 and FIG. 3, is constructed from a flat board, as shown in FIGS. 1(1) and 3(7). The board surface can be textured or smooth. It is made of any flat and stiff material that can provide a consistently level work surface, such as wood, plastic, or glass.

In the construction of the plastic or wood leveling board, as shown in FIG. 1, one hole is drilled into the flat board, as shown in FIG. 1(1), on each of its four corners. A threaded insert nut, as shown in FIG. 2(6) is screwed into each hole. This allows for the secure and smooth clockwise and counterclockwise movement of the thumb screws, as shown in FIG. 2(5). A plastic or wood leveling board corner cutaway displays this, as shown in FIG. 2.

In the construction of the glass variation of the leveling board, as shown in FIG. 3, the coupling nut, as shown in FIG. 4(10) is glued into a coupling nut bracket, as shown in FIG. 4(9). A coupling nut bracket, as shown in FIG. 4(9), is then glued to the bottom side of each of the four corners of the glass flat board, as shown in FIG. 3(7). A perspective view of the bottom of the glass board corner is displayed in FIG. 4.

The bubble level, as shown in FIG. 1(3), is glued into a bubble level bracket, as shown in FIG. 1(2) and FIG. 3(8). The bubble level brackets are directly attached onto adjacent side edges or bottom edges of the flat board, as shown in FIG. 1(1) and FIG. 3(7).

The bubble level bracket, as shown in FIG. 1(2) and FIG. 3(8), is used to secure a bubble level, as seen in FIG. 1(3) and FIG. 3(3), to the flat board, as shown in FIG. 1(1) and FIG. 3(7) on two adjoining sides. The bubble level bracket, as shown in FIG. 1(2), is secured with bubble level bracket screws, as shown in FIG. 1(4), for plastic or wood leveling boards, as shown in FIG. 1, or secured with glue for glass leveling boards, as shown in FIG. 3.

### BACKGROUND OF THE INVENTION

Prior to the invention of the leveling board, as shown in FIG. 1 and FIG. 3, users did not have an easy way to level their work surfaces. Users would place items like cardboard under their projects or under table legs to obtain a level work surface. This method was inefficient, oftentimes resulting in a waste of time and a somewhat level surface.

Since the invention of the leveling board, users have used the leveling board, as shown in FIG. 1 and FIG. 3, in multiple ways, which includes but are not limited to, leveling a piece of small equipment, leveling chemicals being measured in a lab, and creating liquid media art. Jewelry makers, candle makers, and artistic painters have also used the leveling board, as shown in FIG. 1 and FIG. 3, to create their art. The most popular use for the leveling board, as shown in FIG. 1 and FIG. 3, has been by artists who pour resin.

Artists use the leveling board, as shown in FIG. 1 and FIG. 3, to create a level surface that stops the pooling of media to one side on their molds. When an artist does not have a level surface, pooling on one side of their mold occurs. This may ruin their artistic piece.

### BRIEF DESCRIPTION

The leveling board, as shown in FIG. 1 and FIG. 3, solves the surface leveling issues for users by providing a more accurate and easier leveling tool.

The leveling board, as shown in FIG. 1 and FIG. 3, can be made into different dimensions and in the shape of a rectangle or square. It can be made from any type of wood or plastic or tempered glass. It can also come in different colors.

The leveling board, as shown in FIGS. 1 and 3, has two or four bubble levels, as shown in FIG. 1(3). The bubble levels, as shown in FIG. 1(3), are glued into the level brackets, as shown in FIG. 1(2) and FIG. 3(8).

The bubble level bracket, as shown in FIG. 1(2), is screwed on the side of the wood or plastic flat board, as shown in FIG. 1(1). The bubble level brackets, as shown in 3(8), are glued to the bottom of the glass flat board, as shown in FIG. 3(7).

For wood or plastic leveling boards, as shown in FIG. 1(1), a hole is drilled into each corner. A threaded insert nut, as shown in FIG. 2(6), is placed in each hole by twisting it in securely. The thumb screws, as shown in FIG. 2(5), are then screwed into the threaded insert nut, as shown in FIG. 2(6).

The plastic or wood leveling board, as shown in FIG. 1, is set on the user's work surface. Two adjacent thumb screws, as shown in FIG. 1(5), are then screwed into the threaded insert nuts, as shown in FIG. 2(6). The user turns the thumb screws, as shown in FIG. 1(5), concurrently by hand, clockwise or counterclockwise, based on whether the user wants to raise a side to make the leveling board, as shown in FIG. 1, level. This step is continued on the next adjacent, perpendicular side of the leveling board, as shown in FIG. 1, until the bubbles are centered in both levels, as shown in FIG. 1(3). The item to be leveled is set upon the leveling board, as shown in FIG. 1, and is then considered level.

The glass leveling board, as shown in FIG. 3, is set on the user's work surface. Two adjacent thumb screws, as shown in FIG. 3(5), are then screwed into the threaded coupling nuts, as shown in FIG. 4(10). The user turns the thumb screws, as shown in FIG. 3(5), concurrently by hand, clockwise or counterclockwise, based on whether the user wants to raise a side to make the leveling board, as shown in FIG. 3, level. This step is continued on the next adjacent, perpendicular side of the leveling board, as shown in FIG. 3, until the bubbles are centered in both levels, as shown in FIG. 3(3). The item to be leveled is set upon the leveling board, as shown in FIG. 3, and is then considered level.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail by the accompanying drawings in which:

FIG. 1 is a perspective view of a leveling board according to a first embodiment of the present disclosure.

FIG. 2 cutaway view of the corner of a leveling board according to a first embodiment of the present disclosure.

FIG. 3 is a perspective view of a leveling board according to a second embodiment of the present disclosure.

FIG. 4 is a perspective view from the bottom corner of a leveling board according to a second embodiment of the present disclosure

FIG. 5 is a front view of a leveling board according to a first embodiment of the present disclosure.

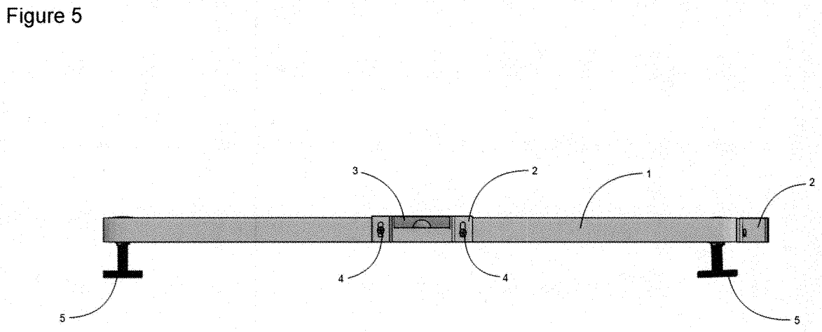

FIG. 6 is a side view of a leveling board according to a first embodiment of the present disclosure.

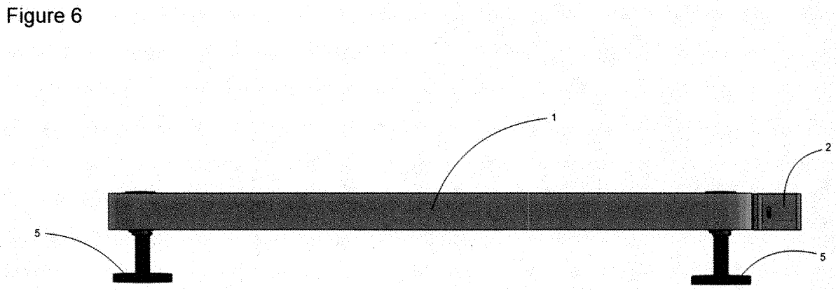

FIG. 7 is a top view of a leveling board according to a first embodiment of the present disclosure.

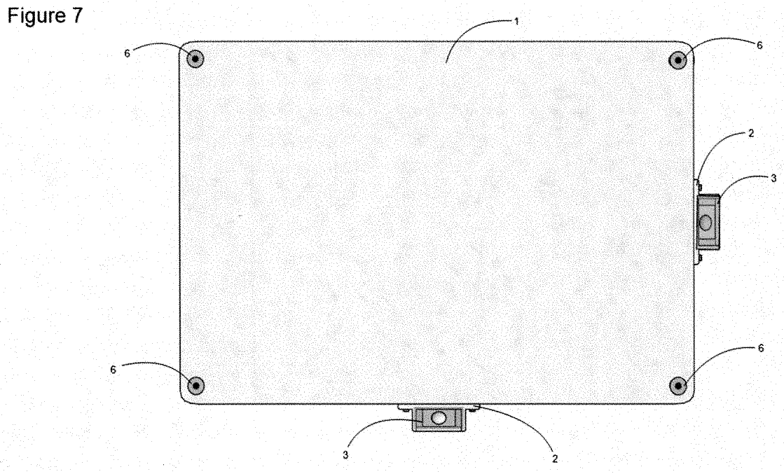

FIG. 8 is a bottom view of a leveling board according to a first embodiment of the present disclosure.

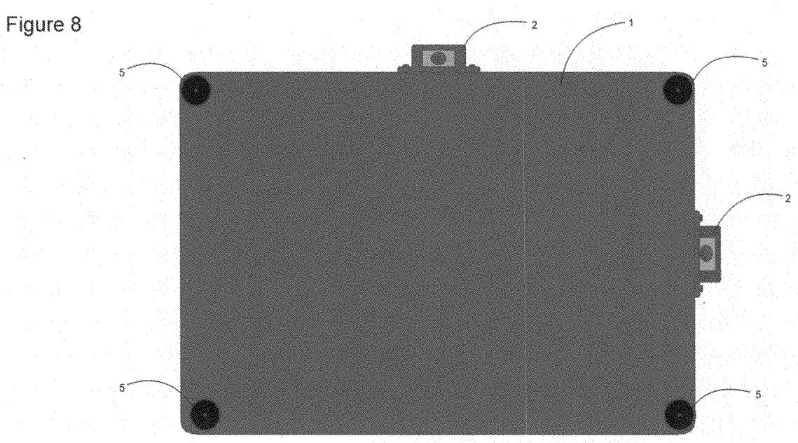

FIG. 9 is a front view of a leveling board according to a second embodiment of the present disclosure.

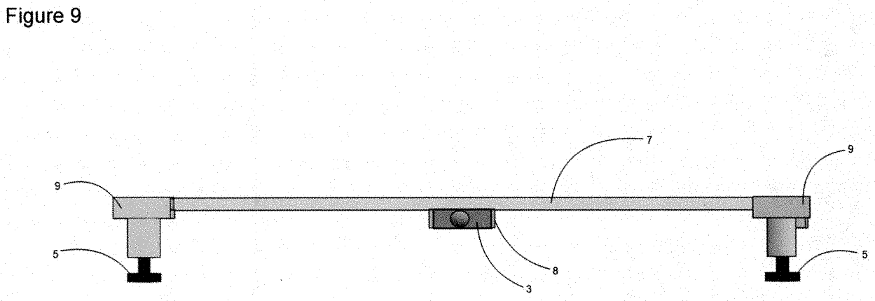

FIG. 10 is a side view of a leveling board according to a second embodiment of the present disclosure.

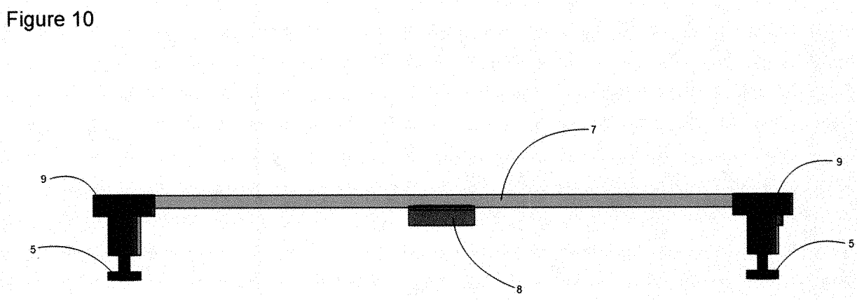

FIG. 11 is a top view of a leveling board according to a second embodiment of the present disclosure.

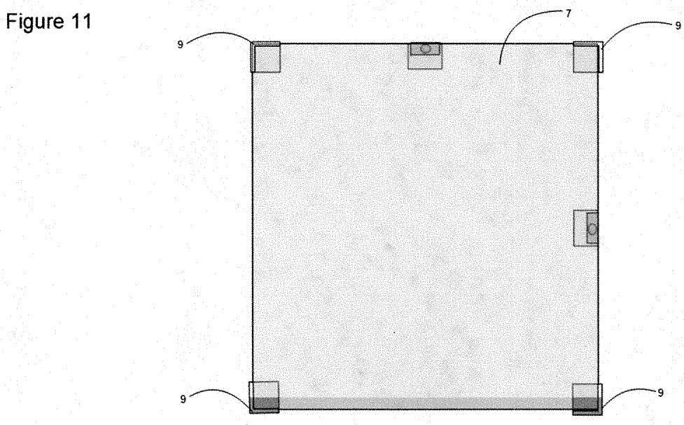

FIG. 12 is a bottom view of a leveling board according to a second embodiment of the present disclosure.

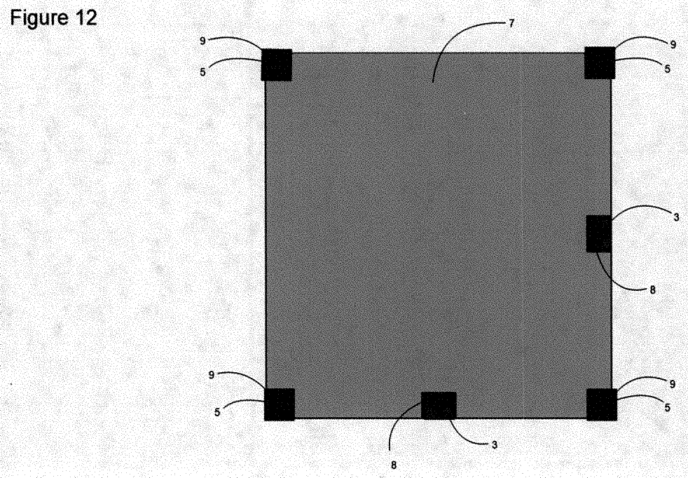

### PATENT SEARCH

| | |
|---|---|
| 10,492,599 | Folding leg assembly for self-leveling table |
| 7,647,872 | Folding, auto-leveling extension table |
| 6,618,120 | Devices and methods for compensating for tilting of |
| | a leveling table in a microlithography apparatus |
| 6,574,808 | Imaging table leveling system |
| 6,536,725 | Table leg leveling device |
| 6,488,438 | Board leveling apparatus and method |
| 6,382,109 | Self-leveling modular table and method of forming |
| | a level modular table |
| 4,374,497 | Leveling table |
| 4,064,814 | Self-leveling extendable table |

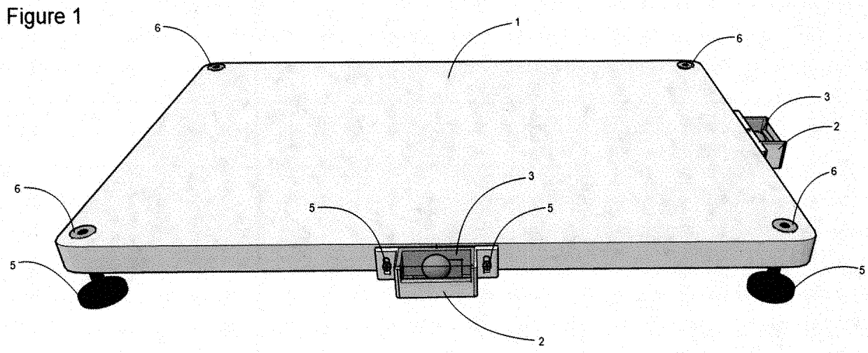

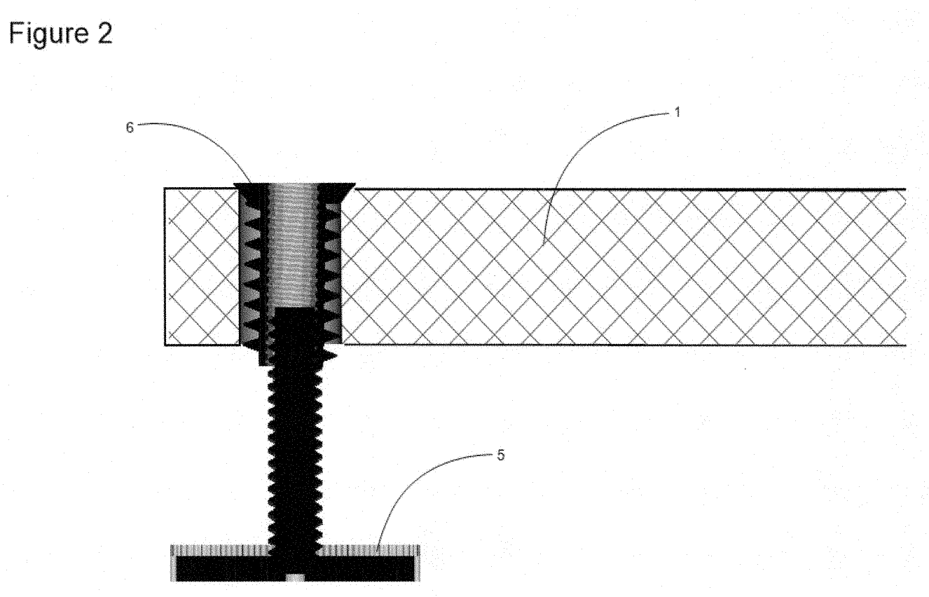

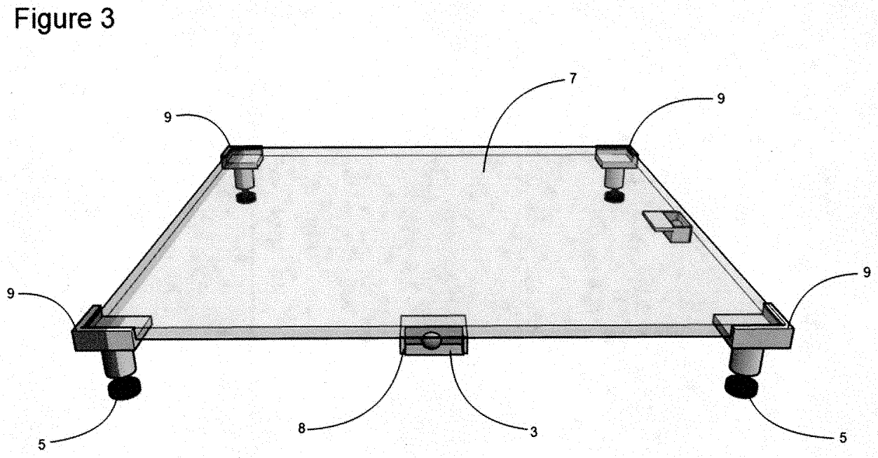

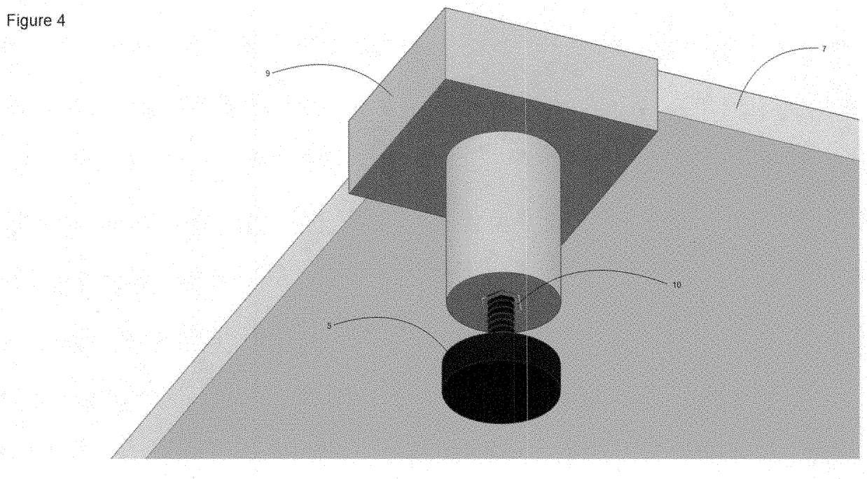

1. I claim any product used to create a level work surface, using the below listed items as described, is a leveling board, also known as leveling table, as shown in FIG. 1 and FIG. 3, for the purpose of this patent.
a: Flat Board. The flat board as shown in FIG. 1(1) and FIG. 3(7) can be textured or smooth; made of wood, plastic, or tempered glass; in the shape of a square or rectangle; and with any dimension or color.
b. Hole. One hole drilled into the wood or plastic flat board, as shown in FIG. 1(1), on each of its four corners.
c. Threaded Insert Nut. The threaded insert nut, as shown in FIG. 2(6), placed into each hole in each of the four corners of the flat board, as shown in FIG. 1(1) and FIG. 3(7), that allows the thumb screw, as shown in FIG. 2(5), to move up or down securely, as shown in FIG. 2.
d. Coupling Nut. The coupling nut, as shown in FIG. 4(10), is glued into a coupling nut bracket, as shown in FIG. 4(9), which is glued to each of the four corners of the flat board, as shown in FIG. 3(8). The coupling nut allows the thumb screw, as shown in FIG. 3(5), to move up or down securely. An example of this is displayed in FIG. 4.
e. Thumb Screws. The thumb screws, as shown in FIG. 2(5) and FIG. 3(5), are used to move the leveling board, as shown in FIG. 1 and FIG. 3, up or down, when hand screwed clockwise or counterclockwise. The thumb screws, as shown in FIG. 2(5), are screwed into the threaded insert nut, as shown in FIG. 2(6), for the wood or plastic board, and the coupling nut, as shown in FIG. 4(10), for the glass board, as shown in FIG. 3(7).
f. Bubble Levels. The bubble levels, as shown in FIG. 1(3), are glued into a bubble level bracket, as shown in FIG. 1(2) and FIG. 3(8). The bubble levels show that the leveling board, as shown in FIGS. 1 and 3, is level, when the bubble in the bubble level is in the center.
g. Bubble Level Brackets. The bubble level brackets for the plastic or wood leveling board, as shown in FIG. 1(2), is a bracket that holds the bubble level, as shown in FIG. 1(3), and is securely screwed to two adjacent side edges of the wood or plastic flat board, as shown in FIG. 1(1).
h. Bubble Level Brackets. The bubble level brackets for glass leveling boards, as shown in FIG. 3(8), which holds the bubble levels, as shown in FIG. 1(3), are glued securely to two or four adjacent bottom edges of the flat board, as shown in FIG. 3(7).
i. Bracket Screws. as shown in FIG. 1(4), are used to screw the screwed bubble level brackets, as shown in FIG. 1(2), to the wood or plastic flat board, as shown in FIG. 1(1).
j. Coupling Nut Bracket. as shown in FIG. 4(9), is used to hold the coupling nut, as shown in FIG. 4(10). The coupling nut, as shown in FIG. 4(10), is glued into the bracket, as shown in FIG. 4(9). A coupling nut bracket, as shown in FIG. 4(9), is then glued to the underside of each of the four corners of the flat board, as shown in FIG. 3(7).
I claim this as my invention for the purpose of this patent.
